(19) United States
(12) Patent Application Publication
(10) Pub. No.: US 2024/0110577 A1
(43) Pub. Date: Apr. 4, 2024

(54) PLASTIC CEILING FAN BLADE WITH A SAFETY STRUCTURE

(71) Applicant: Kuo-Tsun LIN, Taichung City (TW)

(72) Inventor: Kuo-Tsun LIN, Taichung City (TW)

(21) Appl. No.: 17/956,463

(22) Filed: Sep. 29, 2022

(51) Int. Cl. F04D 29/38; F04D 19/00; F04D 29/32

(52) U.S. Cl. CPC F04D 29/388; F04D 19/002; F04D 29/325

(57) ABSTRACT

A plastic ceiling fan blade includes a blade unit and a reinforcing member. The blade unit has a mounting end, a blade tail end that is opposite to the mounting end in a longitudinal direction, and at least one mounting portion that is adjacent to the mounting end. The blade unit defines a blade total length in the longitudinal direction from the mounting end to the blade tail end. The reinforcing member is disposed on the blade unit, is adjacent to the mounting end, and extends toward the blade tail end. The reinforcing member has one end that faces the blade tail end and that is closer to the blade tail end than the at least one mounting portion is.

### FIELD

The disclosure relates to a ceiling fan blade, in particular to a plastic ceiling fan blade having a safety structure.

### BACKGROUND

A conventional ceiling fan blade used for a ceiling fan is shown in FIG. 1. The conventional ceiling fan blade is generally made of plastic material, such as PC, ABS, etc. When the ceiling fan blade has been used for a long time, however, it may be subjected to the effects of external force or temperature changes and result in being torn up during usage. When such breaking up occurs during high speed rotation, the broken pieces can fly off and cause unexpected safety hazards. In general the breaking point of the ceiling fan blade in such a situation is largely within the one third of the blade total length from the inner end of the ceiling fan blade.

### SUMMARY

Therefore, an object of the present disclosure is to provide a plastic ceiling fan blade with a safety structure that is capable of overcoming at least one of the drawbacks of the abovementioned prior art.

Accordingly, the plastic ceiling fan blade includes a blade unit and a reinforcing member.

The blade unit has a mounting end, a blade tail end that is opposite to the mounting end in a longitudinal direction, and at least one mounting portion that is adjacent to the mounting end. The blade unit defines a blade total length in the longitudinal direction from the mounting end to the blade tail end.

The reinforcing member is disposed on the blade unit, is adjacent to the mounting end, and extends toward the blade tail end. The reinforcing member has one end that faces the blade tail end and that is closer to the blade tail end than the at least one mounting portion is.

### BRIEF DESCRIPTION OF THE DRAWINGS

Other features and effects related to the present disclosure will be clearly presented in the embodiments with reference to the drawings, of which:

FIG. 1 is a planar view of a conventional ceiling fan blade, illustrating the range of the ceiling fan blade where the blade breaking usually occurs;

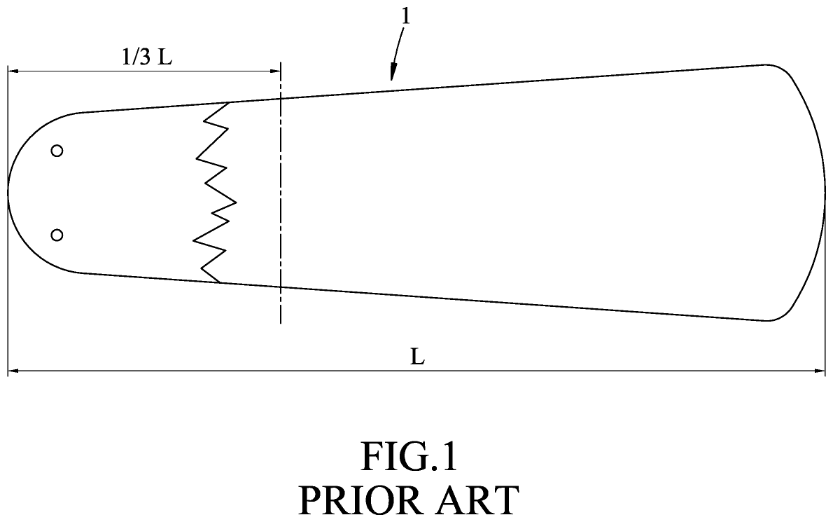

FIG. 2 is a planar view of a plastic ceiling fan blade according to the first embodiment of the present disclosure;

FIG. 3 is a fragmentary sectional view taken along line III-III line in FIG. 2;

FIG. 4 is a fragmentary sectional view taken along the IV-IV line in FIG. 3; and

FIG. 5 is a planar view of a plastic ceiling fan blade, according to the second embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

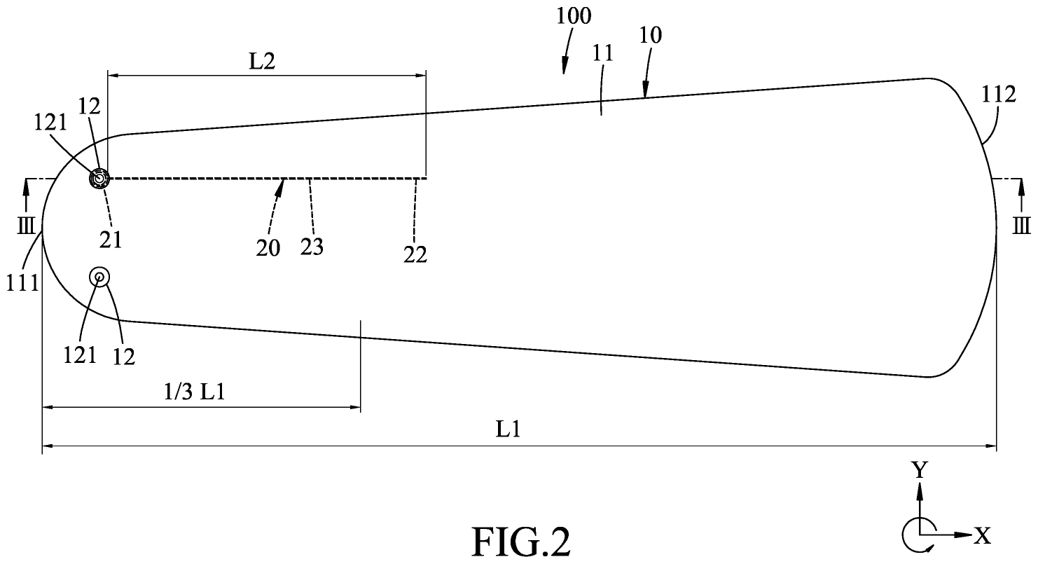

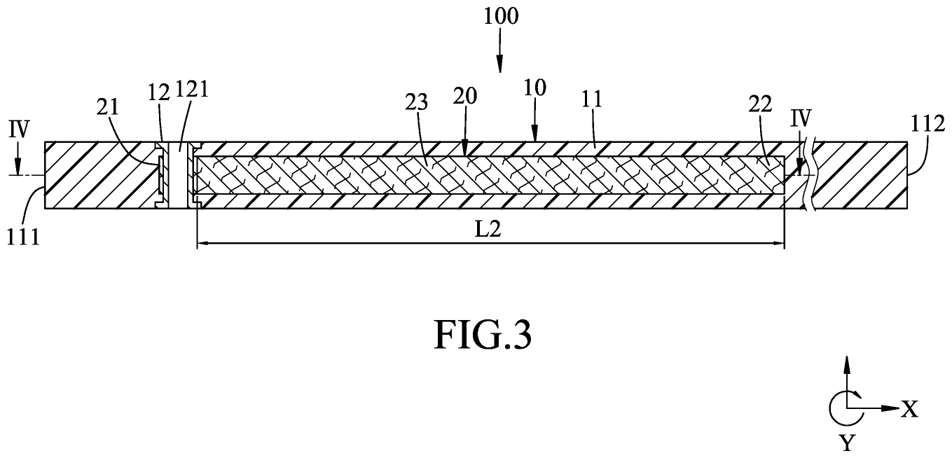

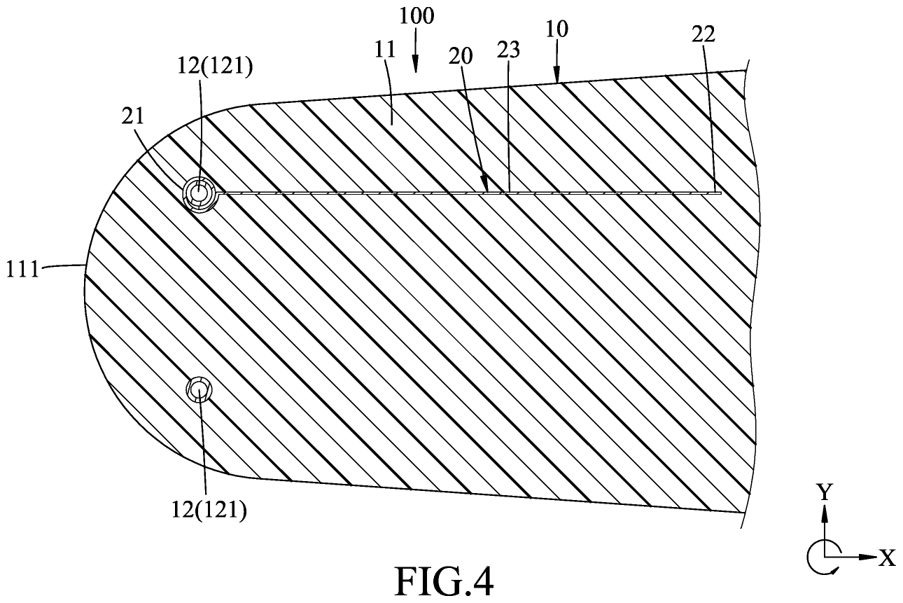

FIGS. 2, 3 and 4 together illustrate a first embodiment of a plastic ceiling fan blade 100 having a safety structure according to the present disclosure. The plastic ceiling fan blade 100 includes a blade unit 10 and a reinforcing member 20.

The blade unit 10 includes a blade body 11 extending in a longitudinal direction (X), and two mounting members 12 fixed to the blade body 11 and spaced apart in a transverse direction (Y) that is transverse to the longitudinal direction (X).

The blade body 11 has a mounting end 111, and a blade tail end 112 that is opposite to the mounting end 111 in the longitudinal direction (X). The blade body 11 defines a blade total length (L1) in the longitudinal direction (X) from the mounting end 111 to the blade tail end 112. In the first embodiment, the material of the blade body 11 is plastic.

The mounting members 12 are adjacent to the mounting end 111, and each of the mounting members 12 has a mounting portion 121.

In the first embodiment, the mounting members 12 are embedded in the blade body 11, the mounting portion 121 of each mounting member 12 is a through hole and is adjacent to the mounting end 111 of the blade body 11. The mounting portions 121 of the mounting members 12 are spaced apart in the transverse direction (Y). The material of each mounting member 12 is metal.

Furthermore, it is understood that when the plastic ceiling fan blade 100 is installed on a ceiling fan body (not shown), two bolts (not shown) are inserted respectively through the mounting portions 121 of the mounting members 12 to fasten the plastic ceiling fan blade 100 to the ceiling fan body.

The reinforcing member 20 is disposed inside the blade unit 10, is adjacent to the mounting end 111 and extends from one of the mounting members 12 toward the blade tail end 112. The reinforcing member has one end facing the blade tail end 112 and being closer to the blade tail end 112 than the one of the mounting members 12 is.

In the first embodiment, the reinforcing member is fixedly disposed inside the blade body 11. The reinforcing member 20 has an inner end portion 21 wound around the one of the mounting members 12, an outer end portion 22 facing the blade tail end 112 and opposite to the one of the mounting members 12, and an extension portion 23 interconnecting the inner end portion 21 and the outer end portion 22. A length of the reinforcing member 22 in the longitudinal direction (X) is not less than one third of the blade total length (L1). Specifically, a reinforcing length (L2), which is directed to a total length in the longitudinal direction (X) of the extension portion 23 and the outer end portion 22, is not less than one third of the blade total length (L1). The outer end portion 22 is closer to the blade tail end 112 than the one of the mounting members 12 is. In addition, the reinforcing member 20 is a glass fiber woven fabric, but is not limited thereto, and the reinforcing member 20 may be made of other materials.

It is understood that, during the manufacturing of the plastic ceiling fan blade 100, the reinforcing member 20 is first wound around the one of the mounting members 12, and after the reinforcing member and the mounting members 12 are placed together into an injection mold (not shown), plastic material is injected into the injection mold to form the blade body 11, so as to allow the mounting members 12 to be embedded inside the blade body 11 and the reinforcing member 20 to be fixedly mounted in the inner portion of the blade body 11. However, a method of manufacturing the plastic ceiling fan blade 100 is not limited to what is disclosed herein.

Therefore when after long time of usage, if the plastic ceiling fan blade 100 accidentally breaks during operation because of the stresses from temperature changes or external force, the reinforcing member 20 in the plastic ceiling fan blade 100 can hold onto the broken portion of the blade body 11, thereby preventing the broken portion of the blade body 11 from flying off under high-speed rotation, and avoiding accidental injury.

With the above description, the advantages of the present disclosure can be summarized as follows:

The plastic ceiling fan blade 100 of the present disclosure utilizes the safety structure of the reinforcing member 20 that has the reinforcing length (L2) not less than one third of the blade total length (L1) of the blade body 11, such that the reinforcing member 20 can effectively cover the conventional breaking range of the blade body 11. Therefore in the situation where during the operation when a blade body 11 of a plastic ceiling fan blade 100 accidentally breaks, the reinforcing member 20 can hold the broken portion of the blade body 11 and prevent the broken portion of the blade body 11 from flying off under high-speed rotation, thereby preventing accidental injury.

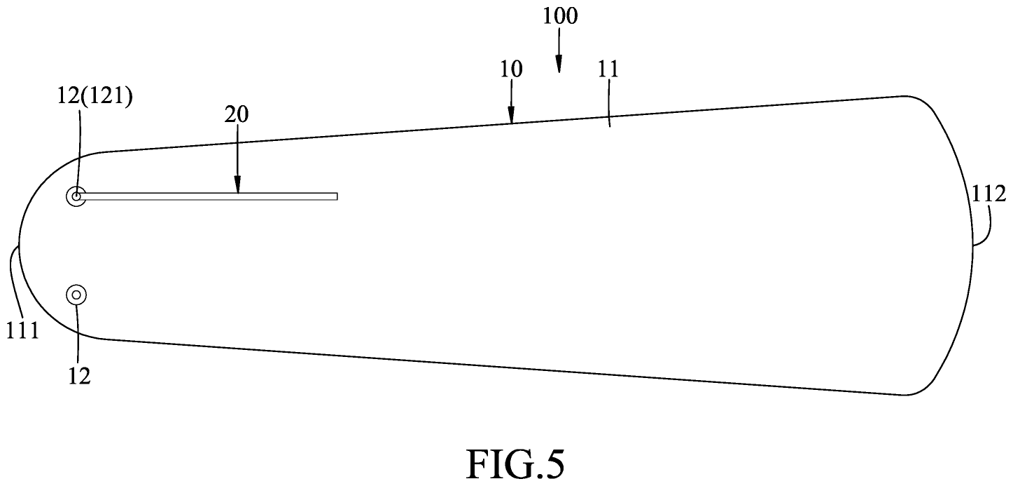

FIG. 5 illustrates a second embodiment of the plastic ceiling fan blade 100 according to the present disclosure. The second embodiment is similar to the first embodiment, whereas the difference between the second embodiment and the first embodiment lies in the following.

The reinforcing member 20 is fixedly disposed on an outer surface of the blade body 11 of the blade unit 10, and the reinforcing member 20 extends from the mounting portion 121 of one of the mounting members 12 toward the blade tail end 112.

As such, the second embodiment may also achieve the same purpose and effect as of the aforementioned first embodiment.

In summary, the plastic ceiling fan blade 100 with a safety structure of the present disclosure can utilize the reinforcing member 20 to hold the broken portion of the blade body 11, thereby effectively preventing the broken portion of the blade body 11 from flying off under high-speed rotation, thereby warding off accidental injury, and thus the object of the present disclosure can indeed be achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

1. A plastic ceiling fan blade comprising:
a blade unit having a mounting end, a blade tail end that is opposite to said mounting end in a longitudinal direction, and at least one mounting portion that is adjacent to said mounting end, said blade unit defining a blade total length in said longitudinal direction from said mounting end to said blade tail end; and
a reinforcing member disposed on said blade unit, being adjacent to said mounting end, and extending toward said blade tail end, said reinforcing member having one end that faces said blade tail end and that is closer to said blade tail end than said at least one mounting portions is to said blade tail end;
wherein said reinforcing member has a length in the longitudinal direction that is not less than one third of said blade total length;
wherein said blade unit includes a blade body and at least one mounting member fixed to said blade body, said blade body having said mounting end and said blade tail end, said at least one mounting member being adjacent to said mounting end and having said at least one mounting portion, said reinforcing member extending from said mounting member toward said blade tail end; and
wherein said at least one mounting member is embedded in said blade body, said reinforcing member being fixedly disposed inside said blade body, said reinforcing member having an inner end portion that is wound around said at least one mounting member, an outer end portion that faces said blade tail end and that is opposite to said at least one mounting member, and an extension portion that interconnects said inner end portion and said outer end portion.

2. (canceled)

3. The plastic ceiling fan blade as claimed in claim 1, wherein said blade unit has two mounting portions spaced apart in a transverse direction that is transverse to said longitudinal direction.

4. The plastic ceiling fan blade as claimed in claim 3, wherein said reinforcing member extends from one of said mounting portions toward said blade tail end.

5. (canceled)

6. (canceled)

7. (canceled)

8. The plastic ceiling fan blade as claimed in claim 1, wherein:
said blade unit includes two mounting members that are spaced apart in a transverse direction transverse to said longitudinal direction, that are adjacent to said mounting end, and that respectively have two mounting portions;
said mounting portion of each of said mounting members is a through hole; and
said reinforcing member extends from one of said mounting members toward said blade tail end.

9. (canceled)

10. (canceled)
